(19) United States
(12) Patent Application Publication
(10) Pub. No.: US 2019/0144160 A1
(43) Pub. Date: May 16, 2019

(54) METHOD AND EQUIPMENT FOR MANUFACTURING A PACKAGE, AND PACKAGE THUS FORMED

(71) Applicant: ESATEC - Etudes Services Automatismes Techniques, Puymoyen (FR)

(72) Inventor: Francis Laroche, Soyaux (FR)

(21) Appl. No.: 16/308,787

(22) PCT Filed: Jun. 8, 2017
(86) PCT No.: PCT/FR2017/051445

§ 371 Date: Dec. 10, 2018

(30) Foreign Application Priority Data
Jun. 9, 2016 (FR) 1655280

(51) Int. Cl. B65D 8/00; B65D 5/32; B65D 5/42

(52) U.S. Cl. CPC B65D 15/22; B31B 2105/0022; B65D 5/4204; B65D 5/328

(57) ABSTRACT

A method for manufacturing a package composed of two cardboard bases and a window extending on the lateral faces between the cardboard bases involves preparing cardboard cutouts by cutting out, from a sheet, two parts that correspond, respectively, to the shape of the first and second cardboard base joined together by separable connecting zones. The cutouts are placed on a conveyor belt. Pressing rollers are applied to the cutouts and one of the rollers in contact with one of the parts is slowed down with respect to the roller in contact with the other part in order to cause tearing of the separable zones. The two parts are repositioned by moving them apart by a distance corresponding to the height of the window. The window is deposited in order to bond the edges on the corresponding edges of the parts, which are thus repositioned.

### CROSS-REFERENCE TO RELATED APPLICATIONS

This application is a national phase entry under 35 U.S.C. § 371 of International Patent Application PCT/FR2017/051445, filed Jun. 8, 2017, designating the United States of America and published as International Patent Publication WO 2017/212176 A1 on Dec. 14, 2017, which claims the benefit under Article 8 of the Patent Cooperation Treaty to French Patent Application Serial No. 1655280, filed Jun. 9, 2016.

### TECHNICAL FIELD

The present disclosure relates to the field of cardboard and more particularly cardboard packages with a window made of plastic or a flexible, transparent material.

The behavior of the two materials is very different, in terms of adaptability, flexibility, resistance, etc.

The window is advantageously transparent. It can be cut from a sheet of PVC, PET, PP, cardboard or any other material.

Assembling these different elements is not always easy or easily industrialized.

### BACKGROUND

International patent application WO 2007/116150 describes a one-piece corrugated cardboard blank for the production of a display case comprising a belt comprising at least four main rectangular flaps, connected together by parallel fold lines, and provided with two series of flaps located on either side, capable of forming at least partially the bottom and the top of the case, respectively, wherein the belt comprises a precut transverse line for splitting the blank into two half-blanks, with the transverse line determining on either side and for each parallel fold line, two separate fold-line portions that are offset with respect to one another so as to make it possible at least in part to compensate for the cardboard thicknesses when wrapping the second half-blank over the first half-blank around a mandrel. This patent application also describes a method for manufacturing a polygonal section package case from a single blank of corrugated cardboard sheet, comprising a belt having at least four main rectangular flaps, connected to each other by two parallel fold lines, and provided with two series of flaps located on either side, capable of forming at least partially the bottom and the top of the body respectively, with the belt comprising a precut transverse line making it possible to divide the blank into two half-blanks, wherein, after destacking the blank, the two half-blanks are separated, the first half-blank is placed into a transfer channel, the second half-blank is held in a plane higher than that of the transfer channel, the first half-blank is transferred toward a mandrel by gluing it on the way, the first half-blank is wrapped around the mandrel, the transfer channel is then configured to allow the transfer of the second half-blank, the second half-blank is lowered onto the channel, the second half-blank is transferred to the mandrel and is wrapped around the first half-blank itself wrapped around the mandrel to form the side walls of the body, before folding the flaps around the mandrel to form the bottom or upper part of the body.

Also known is U.S. Pat. No. 2,143,957, which describes an exemplary package comprising the combination of a transparent sheet tube composed of cellulose or similar forming a tubular side wall, a pair of shaped elements made of cardboard or similar, with the end members comprising peripheral strip portions adhesively attached to opposite ends of the tubular side wall and marked along lines extending parallel to the direction of the tubular side wall to provide elongated corner turns, and end closure tabs hingedly connected with the package are filled with loose material and the package when it is so filled. Suitable for standing up without support.

U.S. Pat. No. 2,139,626 provides a method for manufacturing a paper container, which includes folding a rectangular blank, applying an adhesive onto a side part thereof, folding the edges of the blank, so that the adhesive treated edge overlaps the opposite edge of the blank, exerting an external pressure onto the folded blank to permanently seal its superposed edges, opening the folded blank in a tubular state, forming a rectangular shaped blank to provide an end closure for the body structure. The end closure blank has foldable marginal portions projecting therefrom, the ends of the folded blank, the marginal portions being separated from each other by V-shaped spaces, the V-shaped spaces being formed by making an acute angular cut at each corner of the blank, bending the marginal portions to provide recesses, by applying an adhesive to the recessed portions of the finishing closure, joining the end closure to the body structure by inserting the end of the body structure into the recesses of the formed end closure and applying external pressure to permanently seal the parts together.

U.S. Pat. No. 3,372,796 describes a package formed by an article having opposed end portions with dissimilar outlines, with a pair of capsules surrounding respective end portions of the article. The package includes means for sealing the caps against the end portions.

Folding cardboard unit blanks, each comprising an integral auxiliary section adapted to be folded so as to provide a particular outline to enclose a portion of the article and adapted to be folded in another manner to provide a different outline to enclose the other portion of the article.

### BRIEF SUMMARY

The purpose of the present disclosure is to provide a solution for the flexible and reliable manufacture of cardboard packages having transparent plastic windows.

In its broadest sense, the present disclosure relates to a method for manufacturing a package consisting of two cardboard bases and a window extending on the lateral faces between the cardboard bases, wherein:
cardboard cutouts are prepared by cutting out, from a sheet, two parts that correspond respectively to the shape of the first and second cardboard bases joined together by separable connecting zones;
the blanks are placed on a conveyor belt;
pressure rollers are applied to a blank;
the slowing down of one of the rollers in contact with one of the parts with respect to the roller in contact with the other part is controlled to cause the breakage of the separable zones;
the two parts are repositioned by moving them apart by a distance corresponding to the height of the transparent window; and
the transparent window is removed to glue the edges to the corresponding edges of the repositioned parts.

Preferably, the blank is placed on a conveyor belt in such a way that the center line passing through the separable zones is oriented perpendicularly to the direction of travel of the conveyor belt, and in that the pressure rollers are arranged transversely.

According to a preferred embodiment, the method according to the disclosure controls the slowing down of the rear roller to break the connection zone and create a longitudinal shift between the two parts separated by a distance corresponding to the height of the window.

Advantageously, the method comprises a step of repositioning the two separated parts by a realigning module to ensure the realignment of the two separated parts.

The disclosure also relates to equipment for manufacturing a package consisting of two cardboard bases and a transparent window extending on the lateral faces between the cardboard bases, wherein the equipment comprises a conveyor belt and two pressure rollers the rotation of which is controlled to cause the slowing down of one of the rollers in contact with one of the parts with respect to the roller in contact with the other part to cause the breaking of the separable zones, and reposition the two parts by moving them apart by a distance corresponding to the height of the transparent window and a means for removing a transparent window and gluing the edges to the corresponding edges of the parts thus repositioned.

Preferably, the equipment for manufacturing packages according to the disclosure also includes a destacker to deposit the blanks onto the conveyor belt and a destacker to deliver the windows.

Advantageously, the equipment also includes a jogger to realign the cut and repositioned parts.

The disclosure also relates to a package comprising two cardboard bases a plastic window between two cardboard bases, wherein the package is manufactured in accordance with a method as described herein.

### BRIEF DESCRIPTION OF THE DRAWINGS

The present disclosure will be best understood upon reading the following detailed description of a non-restrictive exemplary embodiment, while referring to the accompanying drawings, wherein:

FIG. 1 is a perspective view of a package box according to the disclosure;

FIG. 2 shows a flat view of a package box according to the disclosure;

FIG. 3 shows a side view of the cardboard cutout according to the disclosure; and

FIG. 4 is a top view of a machine according to the disclosure.

### DETAILED DESCRIPTION

### Description of One Exemplary Package

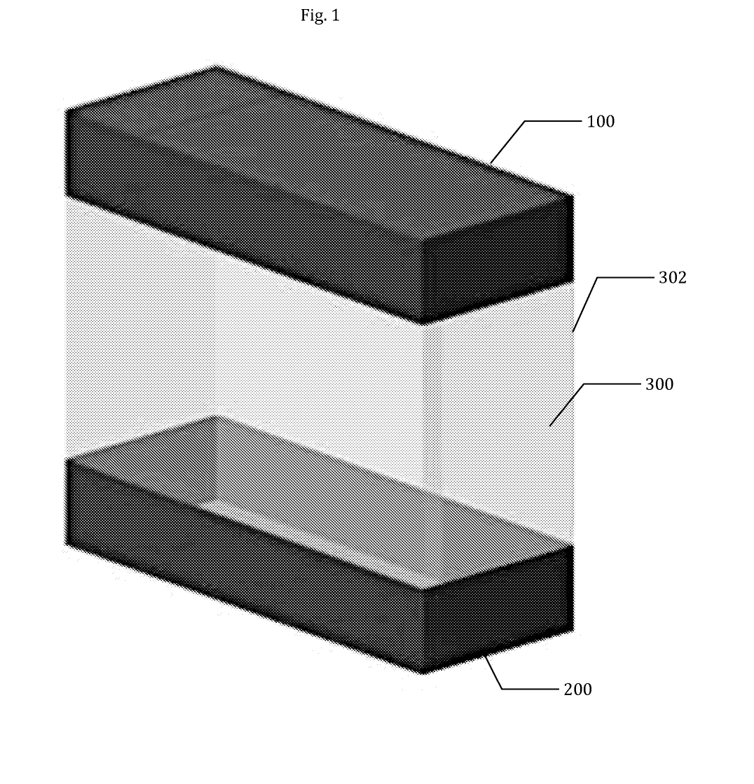

FIG. 1 shows an exemplary package consisting of two cardboard bases 100, 200 and a window 300 arranged between the two cardboard bases 100, 200.

The window 300 is typically cut in a PVC sheet, on which a groove 302 is applied to facilitate folding and prevent the PVC sheet, which is more rigid than cardboard, from tearing the cardboard at an edge in the zone where the cardboard and PVC are joined.

The transparent window 300 may also have indentations 301 on the edges, at the fold lines 302, to prevent the stiffness of the PVC from creating a deformation that exerts pressure onto the cardboard that could lead to a local tearing.

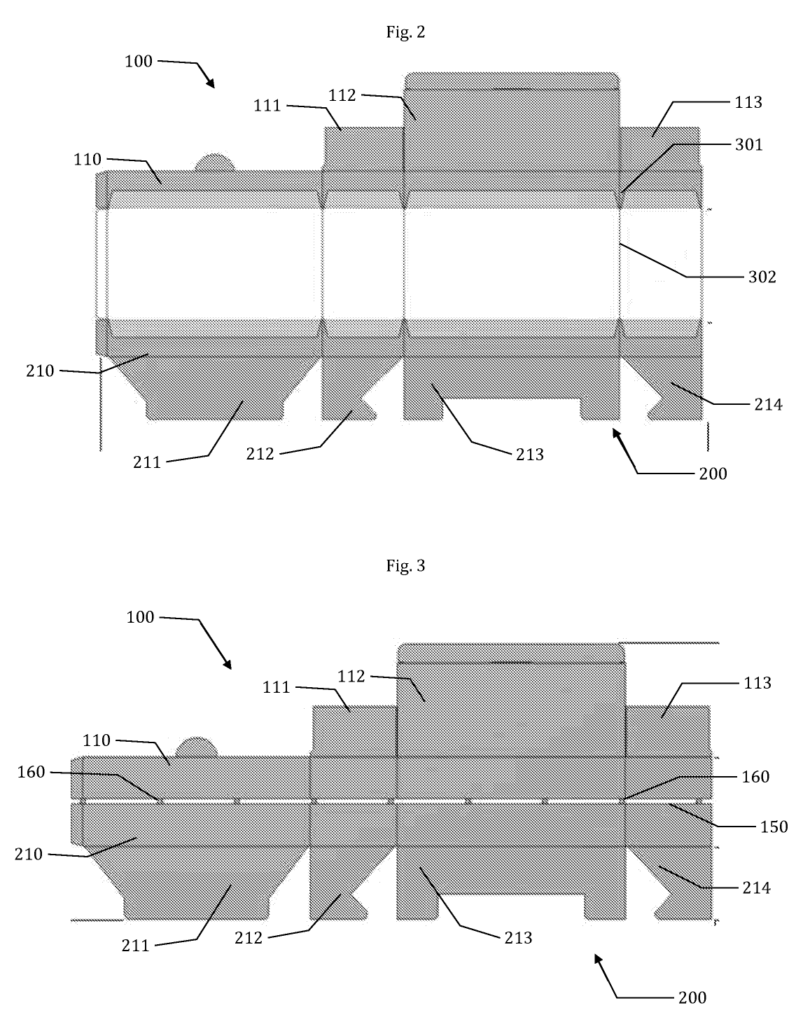

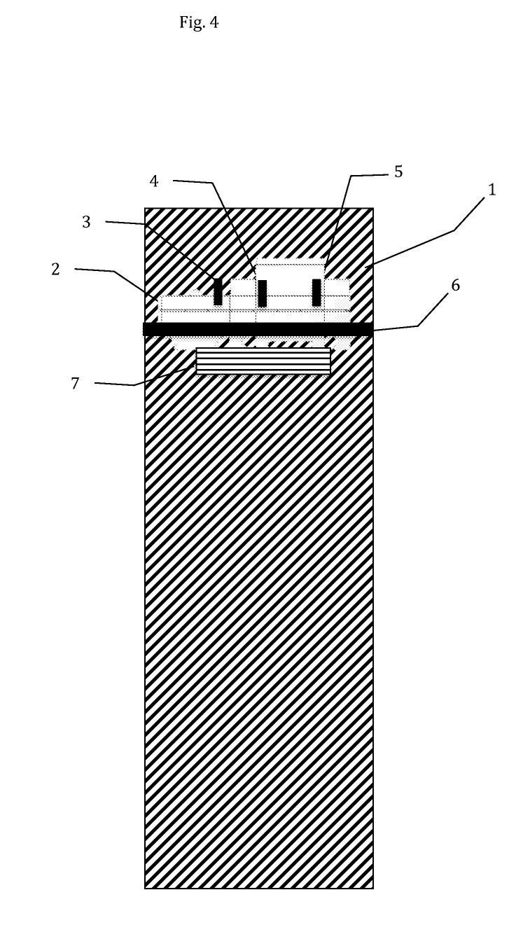

FIG. 2 shows the assembly between the cardboard blanks 100; 200 and the window 300 prior to forming.

The manufacture of a package box according to the disclosure includes the following main steps:

First of all, a series of blanks 100, 200 are cut from a cardboard sheet, separated by a transverse space 150 and punctually connected by separable zones 160, and these blanks are stacked on a destacker.

At the same time, a series of precut and pre-grooved windows are prepared and stored on another destacker.

The cardboard blanks are then dragged, one by one, onto a conveyor belt to a blanks processing station.

The cardboard cutout is stuck, at least for part of its travel, between the conveyor belt and a pair of rollers supported on the upper surface of the cutout. The rollers initially rotate at a speed synchronous with the belt so as to ensure the movement of the cutout without speed differential between the lower part and the upper part.

At this processing station, each of the blanks 100, 200 is then pulled in opposite directions perpendicular to the median of the transverse space 150. Such pulling is achieved by modifying the speed of the two rollers, when they are positioned on either side of the separable zone 160 of the cutout. For example, the roller behind this separable zone is slowed down in order to create a force in a direction perpendicular to the separable line.

This force causes the separable zones 160 to break and allows the two blanks 100, 200 to be moved apart, positioning them opposite each other with an offset corresponding to the transparent sheet of window 300.

A window is then transported in superposition with the two edges of the blanks 100, 200, an adhesive is applied to the edges of the strips 110, 210 and the window is applied to the glued zone.

### Description of a Piece of Equipment for Implementing the Method

FIG. 4 shows a specific example of a piece of equipment for implementing the method according to the disclosure.

The equipment includes a suction belt 1 that runs longitudinally. The cutout 2 is deposited onto this suction belt 1 by a destacker, and slides under pressure rollers 3, 4, 5.

The cutout 2 is then driven between the belt 1 and a motorized transverse roller 6.

A belt jogging module 7 separates the two blanks 100, 200 from the cutout 2.

The purpose of the equipment is to detach and separate, parallel to a predefined distance, the cardboard cutout 2 consisting of two or three pieces held together by separable zones 160.

This separation is carried out continuously in the machine and linearly in the machine pitch.

After the separation of the cutouts 100, 200, a belt jogger 7 realigns the cardboard cutouts 100, 200 in parallel on the suction belt 1 and also ensures the correct positioning at a pre-programmed distance of the cutouts 100, 200 from each other.

During the transfer, the rear blank 100 of the cutout 2 is kept tight between the pressure rollers 6.

The pressure rollers 6 slow down while the front blank 200 of the cardboard cutout 2 travels on at the same speed as the suction belt 1 and is maintained under pressure by the pressure rollers 3, 4, 5 on the belt 1.

After separating the blanks 100, 200, the rollers 6 accelerate to return to the same speed as the belt 1 at a specific time, previously determined by the separation length of the two cuts 100, 200.

The separated blanks 100, 200 advance to the belt jogging module 7.

The blanks 100, 200 are then realigned by pushing and holding the right edges of the two cardboard blanks 100, 200.

A motorized toothed belt equipped with a cleat welded and synchronized to the feed of the blanks 100, 200, ensures braking and acceleration of the blanks 100, 200 on the suction belt 1, which also allows the spacing of the two blanks 100, 200 to be accurately finalized.

The belt jogging module 7 consists of two belt carriages mounted in parallel.

The two toothed belts are driven by a splined shaft with ball bushings, allowing each carriage to be adjusted laterally.

Each toothed belt is equipped with a welded cleat.

Each belt has a micro-adjustment device, which allows the two cleats to be aligned in parallel or to make an angular correction of the cardboard cutouts. The settings for synchronizing the cleats/the position of the cutouts can be configured at the machine console.

### Principle for Alignment of 2 Blanks 100, 200:

Phase 1: The cleat pushes, from the back, the first blank 200 of the previously separated cardboard upstream.

Phase 2: Assisting the pushing of the first blank 200 from 2 mm to 5 mm.

Phase 3: End of the assistance to the pushing of the first blank 200 of the cardboard from 2 mm to 5 mm and return of the cleat backwards so that it is positioned on the front edge of the second blank 100.

Phase 4: Slowing down of the second blank 100 from 2 mm to 5 mm with respect to the belt 1, when the separable zone is between the first and the second rollers, then rotation of the cleat for preparing the next cardboard.

1. A method for manufacturing a package comprising first and second cardboard bases and a window extending on lateral faces between the first and second cardboard bases, the method comprising:
preparing cardboard cutouts by cutting out, from a sheet, two parts that correspond respectively to the shape of the first and second cardboard bases joined together by separable connecting zones;
placing the cardboard cutouts on a conveyor belt using a pair of motorized rollers supported on an upper surface of the cardboard cutouts;
slowing down one roller of the pair of motorized rollers in contact with one of the two parts with respect to the roller in contact with the other part in order to cause tearing of the separable connecting zones; and
depositing a window in order to bond the edges on corresponding edges of the two parts that are thus repositioned.

2. The method of claim 1, wherein the cardboard cutouts are deposited onto the conveyor belt in such a way that the center line passing through the separable connecting zones is oriented perpendicularly to the direction of movement of the conveyor belt, and wherein the motorized rollers are arranged transversely.

3. The method of claim 2, wherein the slowing down of the one roller is controlled to cause the separable connecting zone to break and create a longitudinal offset between the two parts such that the two parts are separated by a distance corresponding to the height of the window.

4. The method of claim 1, further comprising repositioning the two parts after the tearing of the separable connecting zones by a jogging module to ensure realignment of the two separated parts.

5. A system for manufacturing a package comprising two cardboard bases and a transparent window extending on lateral faces between the two cardboard bases, the system comprising:
a conveyor belt; and
two pressure rollers, rotation of two pressure rollers being controlled to cause the slowing down of one of the pressure rollers in contact with one of the two cardboard bases relative to the pressure roller in contact with the other cardboard base to cause separable zones to break, and to reposition the separated cardboard bases by moving them away from each other by a distance corresponding to the height of the window; and
a mechanism for placing the window between the repositioned two cardboard bases and gluing the edges to the corresponding edges of the repositioned two cardboard bases.

6. The system of claim 5, further comprising a destacker for depositing the blanks onto the conveyor belt and a destacker for delivering the windows.

7. The system of claim 6, further comprising a jogger for realigning the cut and repositioned two cardboard bases.

8. A box comprising a plastic window between two cardboard bases, wherein the box is manufactured from a cardboard cutout formed from a two-part sheet corresponding respectively to the shape of the two cardboard bases joined together by separable connecting zones, the manufacture of the box being carried out according to the method of claim 1.

9. The system of claim 5, further comprising a jogger for realigning the cut and repositioned two cardboard bases.
